(19) United States
(12) Patent Application Publication
(10) Pub. No.: US 2007/0018965 A1
(43) Pub. Date: Jan. 25, 2007

(54) Illuminated touch control interface

(75) Inventors: Traian Radu Paun, Markham (CA); Filip Atanassov, Oakville (CA)

Correspondence Address: Robert J. Kapalka;Tyco Technology Resources, Suite 140, 4550 New Linden Hill Road, Wilmington, DE, 19808-2952, US

(73) Assignee: Tyco Electronics Canada, Ltd.

(21) Appl. No.: 11/187,483

(22) Filed: Jul. 22, 2005

(51) Int. Cl. G09G 5/00

(52) U.S. Cl. 345/173

(57) ABSTRACT

A touch control interface includes a panel having first and second surfaces. The first surface defines a touch interface area. The panel includes an opening extending entirely between the first and second surfaces, and the panel includes at least one touch sensitive element positioned within the touch interface area. An illumination source is positioned proximate the opening for transmitting light through said opening.

### BACKGROUND OF THE INVENTION

This invention relates generally to touch sensor and touch control technologies, and more particularly, to illuminated keyboard assemblies applicable to touch control technologies.

Due to their convenience and reliability, touch sensitive control interfaces are increasingly being used in lieu of mechanical switches for various products and devices. Conventional touch control interfaces, or touch sensing systems are utilized in a variety of electronic applications such as, for example, appliances, industrial processes or equipment, automotive equipment, kiosks, point of sale terminals, medical equipment, mobile communications, portable electronic entertainment, hand held instrumentation or other electronic applications. The associated device may be finger operated by pressing predefined areas of the interface, and the device typically includes a controller coupled to the interface to operate mechanical and electrical elements of the device in response to user commands entered through the touch control interface.

Various types of technologies are available for use in touch control interfaces, including but not limited to touch sensitive elements such as, for example, capacitive sensors and infrared detectors, and switching elements (e.g., membrane switch assemblies) responsive to touch keypads However, at least one drawback with these known touch control interfaces is the difficulty and expense associated with illuminating the predefined touch area of the interface. In at least some known touch control interfaces, particularly those interfaces utilizing switching elements, lighting is accomplished using a lighting source embedded within a keypad of the interface. In at least some other known touch control interfaces, the keys may be backlit using an illumination source positioned near, but offset with respect to the touch area of the interface.

Additionally, problems exist with positioning lighting sources proximate to the touch sensors. Specifically, the lighting sources may cause signal interference with the touch sensing system when the lighting sources are positioned too close to the touch sensors. As a result, shielding of the touch sensors from the lighting source may be needed. Thus, lighting known touch control interfaces is difficult and costly, or may be inadequate for the particular application.

### BRIEF DESCRIPTION OF THE INVENTION

In one aspect, a touch control interface is provided including a panel having first and second surfaces. The first surface defines a touch interface area. The panel includes an opening extending entirely between the first and second surfaces, and the panel includes at least one touch sensitive element positioned within the touch interface area. An illumination source is positioned proximate the opening for transmitting light through said opening.

Optionally, a transparent cover extends along the panel and defines a touch region overlying the touch interface area. The panel may include a circuit board having signal traces extending along the second surface of the panel. Optionally, the illumination source may include one of a light emitting diode, a light bulb, and an electroluminescent panel, and the illumination source may be substantially aligned with said opening and said touch interface area. The touch sensitive element may extends along an edge of the opening. The opening may be substantially rectangular having opposed lateral walls and opposed longitudinal walls, and the touch sensitive element may extend along the opposed longitudinal walls and one of the opposed lateral walls of the opening. Optionally, the panel may include a plurality of openings having touch sensitive elements surrounding each opening.

In another aspect, a touch control interface is provided including a panel having first and second surfaces, wherein the first surface defines a touch interface area having a touch sensitive element therein. The panel includes a cut-out extending entirely between the first and second surfaces, and the touch sensitive element is positioned adjacent the cut-out. A cover overlies the panel and includes a touch region, wherein the touch region and the touch sensitive element defining a touch sensor for the touch control interface. An illumination source is positioned proximate the cut-out and illuminates the touch region through the cut-out.

In a further aspect, a touch control interface system is provided including a device having a controller and a number of components operatively connected thereto, and a touch control interface communicating with the controller. The touch control interface includes an interface panel having a plurality of openings and a plurality of touch sensitive areas surrounding each opening. The interface panel also includes touch sensitive elements associated with each respective one of the touch sensitive areas. A cover overlies the panel and defining a plurality of touch regions associated with each respective one of the touch sensitive areas. An illumination source is positioned proximate the plurality of openings and illuminates the plurality of touch regions through the plurality of openings.

### BRIEF DESCRIPTION OF THE DRAWINGS

FIG. 1 is an exploded perspective view of a touch control interface for an electronic device and formed in accordance with an exemplary embodiment of the present invention.

FIG. 2 is a perspective view of an upper surface of a component of the touch control interface shown in FIG. 1.

FIG. 3 is a perspective view of a lower surface of the component shown in FIG. 2.

FIG. 4 is a side cross-sectional view of the touch control interface shown in FIG. 1 in an assembled state.

FIG. 5 is an assembled view of the touch control interface and the electronic device shown in FIG. 1.

### DETAILED DESCRIPTION OF THE INVENTION

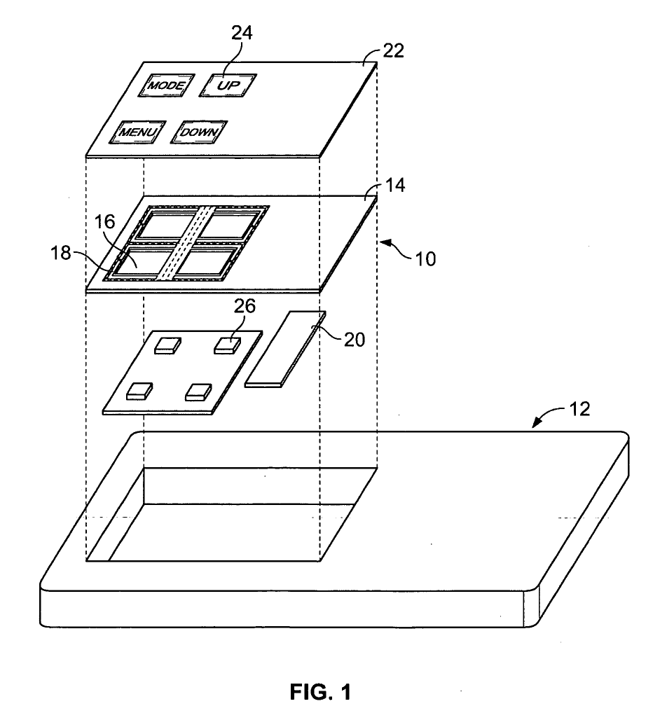

FIG. 1 is an exploded perspective view of a touch control interface 10 for an electronic device or product 12. The device 12 may be applicable to, but is not limited to applications such as appliances, industrial processes or equipment, automotive equipment, kiosks, point of sale terminals, medical equipment, mobile communications, portable electronic entertainment, hand held instrumentation or other electronic applications. More specifically, the touch control interface 10 may be utilized within electronic devices 12 utilizing a human interface such as, for example, touch control technology, padless touch sensor technology, capacitive touch sensing systems, or like systems that use signal generation and detection, as those in the art would appreciate.

The touch control interface 10 includes an interface panel or circuit board 14 having a plurality of openings or cut-outs 16 which are surrounded by touch sensitive elements 18, also referred to hereinafter as touch plates 18. The number of openings 16 and touch sensitive elements 18 may be varied depending on the number of inputs or “keys” associated with the electronic device 12. In one embodiment, and as illustrated in the Figures, the touch control interface 10 includes four openings 16 and four touch sensitive elements 18. The touch control interface 10 also includes a controller 20 that is mounted to the interface panel 14 during assembly and that is operatively coupled to the touch sensitive elements 18, as will be described below in more detail. Moreover, the controller 20 is also operatively coupled to the electronic device 12. The elements 18, and the controller 20 are configured to detect an actual touch, also referred to herein as a touch detection or touch result, at the associated touch sensitive elements 18. Unlike known switching elements (e.g., membrane switch assemblies), touches are detected electronically, and actual mechanical or electrical switching of a conductive path, and associated reliability issues thereof, is avoided.

The touch control interface 10 also includes a cover or dielectric element 22. The cover 22 functions as a touch interface and includes a plurality of touch regions 24 that correspond to the touch sensitive elements 18. Specifically, the touch regions 24 overlie the touch sensitive elements 18 and the openings 16 and provide an area for the user to interface with the touch control interface 10. Optionally, the touch regions 24 may include indicia, such as numbers or characters, indicating the function of the particular key or input of the touch control interface 10. In an exemplary embodiment, the cover 22 is transparent or translucent, or otherwise allows light to pass therethrough. Additionally, in an exemplary embodiment, the cover 22 may be fabricated from a dielectric material, such as for example, glass, plastic, polycarbonate, and the like, and has a thickness selected to allow the touch sensitive elements 18 to detect a “touch” by the user.

The touch control interface 10 also includes an illumination source 26. Optionally, the illumination source 26 may be an illuminating device such as, for example, a light emitting diode (LED), a light bulb, a electroluminescent panel or element, or the like. In the illustrated embodiment, the touch control interface 10 includes four illumination sources 26, and each illumination source 26 is substantially aligned with corresponding openings 16 of the interface panel 14. Alternatively, the illumination sources 26 may be off-set with respect to the openings 16 but nonetheless project light through the openings. Moreover, as will be described in detail below, when the touch control interface 10 is assembled, the light emitted by each illumination source 26 is directed through the openings 16 such that the touch regions 24 of the cover 22 and/or the panel 14 may be illuminated.

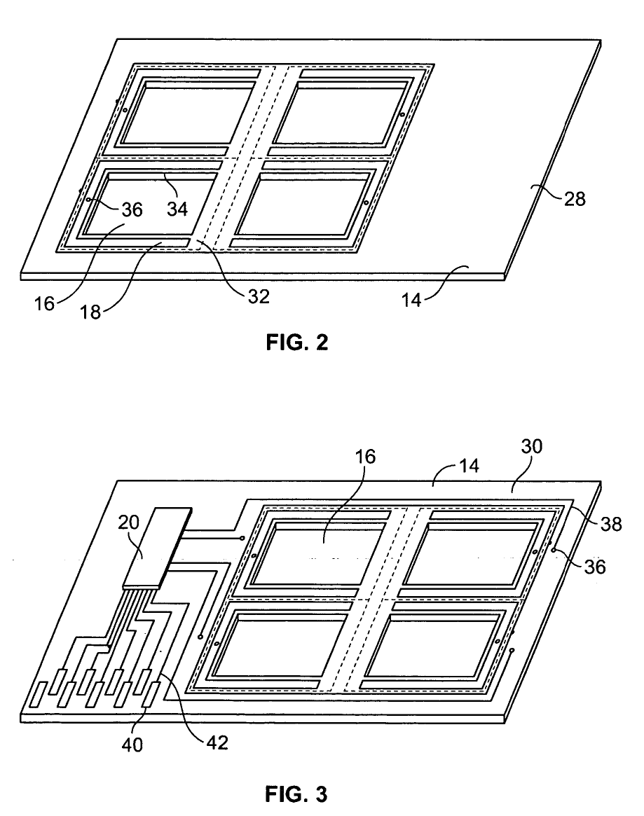

FIGS. 2 and 3 are top and bottom perspective views of an upper surface 28 and a lower surface 30, respectively, of the interface panel 14. The openings 16 extend entirely through the interface panel 14 and between the upper and lower surfaces 28 and 30 such that light can be transmitted through the openings 16.

As illustrated in FIG. 2, the upper surface 28 of the interface panel 14 includes the touch sensitive elements 18. The upper surface 28 is defined as the surface of the interface panel 14 oriented to interface with the user, and as such is outwardly facing when assembled with the electronic device 12 (shown in FIG. 1). The upper surface 28 includes multiple touch interface areas 32, shown in phantom in FIG. 2, corresponding to the touch sensitive elements 18, openings 16 and touch regions 24 of the cover 22 (shown in FIG. 1). In one embodiment, the touch areas 32 extend along the upper surface 28 in a predefined pattern. For example, the touch sensitive elements 18 may be oriented along an outer edge 34 of the openings 16 such that the touch sensitive elements 18 substantially surround the openings 16. As such, the user may activate the touch sensitive element 18 by touching the cover 22 proximate to the opening 16 of the desired input.

In one embodiment, the openings 16 have a substantially rectangular shape, and each touch sensitive element 18 surrounds a corresponding opening 16. Optionally, the touch sensitive elements 18 extend along all four edges of the opening 16. Alternatively, the touch sensitive elements 18 may extend along less than all four edges of the opening 16. For example, and in an exemplary embodiment, the touch sensitive elements 18 have a generally C-shape or a U-shape and extend along three edges of the openings 16. As such, the openings 16 may be positioned relatively closer together. In other alternative embodiments, the openings 16 have a circle or oval shape, and the touch sensitive elements 18 substantially surround the openings 16. However, it is realized that the openings 16 and touch sensitive elements 18 may have other shapes as would be appreciated by those in the art.

In an exemplary embodiment, the touch sensitive elements 18 are fabricated from a conductive material, such as for example, copper and are capacitive touch sensors such as those described in U.S. Pat. No. 5,760,715, the disclosure of which is hereby incorporated by reference in its entirety. When the touch sensor system of U.S. Pat. No. 5,760,715 is employed as the touch sensitive elements 18, and the touch sensitive elements 18 are capacitively distributed around the openings 16, a touch may be detected when the touch sensitive elements 18 associated with the respective touch areas 32 issue a test pulse to earth ground and detect the return of the test pulse through the human user and through the touch area 32. In alternative embodiments, the touch sensitive elements 18 are infrared detectors, or other known tactile or touch-based sensors familiar to those in the art employing voltage sensing, current sensing and the like to detect a user activation of the touch sensitive area. In an exemplary embodiment, each touch sensitive element 18 includes a through-hole or via 36 extending through the interface panel 14 to the lower surface 30 thereof.

As illustrated in FIG. 3, the lower surface 30 of the interface panel 14 includes a plurality of signal traces 38 extending between and electrically and mechanically coupling the touch sensitive elements 18 with the controller 20. The lower surface 30 is generally opposed to and substantially planar with the upper surface 28. In one embodiment, the signal traces 38 extend along the lower surface 30 in a predefined pattern. Specifically, the signal traces 38 extend from the vias 36 to the controller 20. As such, the signal traces 38 and the vias 36 mechanically and electrically connect the controller 20 to the touch sensitive elements 18.

Moreover, the controller 20 is mechanically and electrically coupled to a plurality of contact pads 40 by corresponding contact traces 42. The contact pads 40 are oriented to interface with other electronic components of the electronic product 12, such as, but in no way limited to, a microprocessor for operating the electronic product 12 or a display viewable by the user.

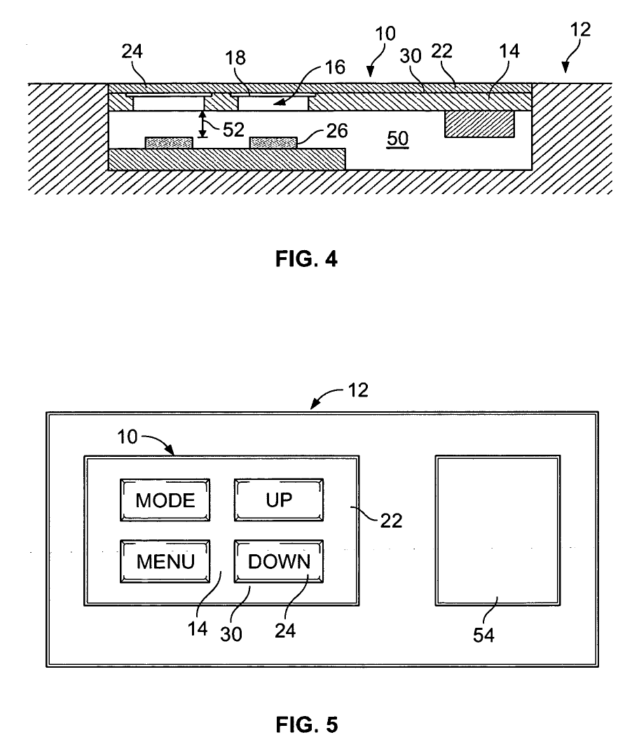

FIG. 4 is a side cross-sectional view of the touch control interface 10 mounted within the electronic device 12, and is optionally mounted within a dedicated cavity 50 of the electronic device 12. The cover 22 is coupled to and extends along the upper surface 28 of the interface panel 14. Additionally, the illumination sources 26 are mounted within the cavity 50 and are generally aligned with the openings 16 extending through the interface panel 14. In one embodiment, the illumination sources 26 are activated upon a touch to the touch region 24 of the cover 22. In another embodiment, the illumination sources 26 are continuously illuminated, or are illuminated for a predetermined time, or in response to a predetermined event. As such, the cover 22, and more particularly, the touch region 24 is backlit by the illumination sources 26. Additionally, because the illumination sources 26 are positioned a distance 52 from the upper surface 28 of the interface panel 14, the risk of interference or signal degradation of the touch sensitive elements 18 with the illumination sources 26 is reduced. As a result, a cost effective and reliable back lighting system is accomplished with the use of the touch control interface 10.

FIG. 5 is an assembled view of the touch control interface 10 and the electronic device 12. The cover 22 and the upper surface 28 of the interface panel 14 of the touch control interface 10 are oriented within the electronic device 12 to define a touch interface. Each of the touch regions 24 of the cover 22 and the touch sensitive elements 18 of the interface panel 14 define keys or inputs for operating the electronic device 12. In one embodiment, the electronic device 12 includes a display 54 operatively coupled to the touch control interface 10.

While the invention has been described in terms of various specific embodiments, those skilled in the art will recognize that the invention can be practiced with modification within the spirit and scope of the claims.

What is claimed is:

1. A touch control interface comprising:
a panel having first and second surfaces, said first surface defining a touch interface area, said panel comprising an opening extending entirely between said first and second surfaces, said panel comprising at least one touch sensitive element positioned within said touch interface area; and
an illumination source positioned proximate said opening for transmitting light through said opening.

2. A touch control interface in accordance with claim 1, further comprising a cover overlying said panel.

3. A touch control interface in accordance with claim 1, further comprising a transparent cover extending along said panel, said cover defining a touch region overlying said touch interface area.

4. A touch control interface in accordance with claim 1, wherein said panel comprises a circuit board having signal traces extending along said second surface of said panel.

5. A touch control interface in accordance with claim 1, wherein said illumination source comprises one of a light emitting diode, a light bulb, and an electroluminescent panel.

6. A touch control interface in accordance with claim 1, wherein said illumination source is substantially aligned with said opening and said touch interface area.

7. A touch control interface in accordance with claim 1, wherein said touch sensitive element extends along an edge of said opening.

8. A touch control interface in accordance with claim 1, wherein said opening is substantially rectangular having opposed lateral walls and opposed longitudinal walls, said touch sensitive element extending along said opposed longitudinal walls and one of said opposed lateral walls of said opening.

9. A touch control interface in accordance with claim 1, wherein said panel comprises a plurality of openings having touch sensitive elements surrounding each opening.

10. A touch control interface comprising:
a panel comprising first and second surfaces, said first surface defining a touch interface area having a touch sensitive element therein, said panel comprising a cut-out extending entirely between said first and second surfaces, said touch sensitive element positioned adjacent said cut-out;
a cover overlying said panel and comprising a touch region, said touch region and said touch sensitive element defining a touch sensor for said touch control interface; and
an illumination source positioned proximate said cut-out and illuminating said touch region through said cut-out.

11. A touch control interface in accordance with claim 10, wherein said cover is one of transparent and translucent, such that light from said illumination source is visible through said cover.

12. A touch control interface in accordance with claim 10, wherein said panel comprises a circuit board having signal traces extending along said second surface thereof.

13. A touch control interface in accordance with claim 10, wherein said touch sensitive element is capacitively distributed along an edge of said cut-out.

14. A touch control interface in accordance with claim 10, wherein said illumination source is substantially aligned with said cut-out and said touch interface area.

15. A touch control interface in accordance with claim 10, wherein said cut-out is substantially rectangular having opposed lateral walls and opposed longitudinal walls, said touch sensitive element extending along said opposed longitudinal walls and one of said opposed lateral walls of said cut-out.

16. A touch control interface in accordance with claim 10, wherein said illumination source comprises one of a light emitting diode, a light bulb, and an electroluminescent panel.

17. A touch control interface in accordance with claim 10, wherein said panel comprises a plurality of said cut-outs and a respective said touch sensitive element surrounding each said cut-out.

18. A touch control interface system comprising:
a device having a controller and a number of components operatively connected thereto; and
a touch control interface communicating with said controller, said touch control interface comprising:
an interface panel comprising a plurality of openings and a plurality of touch sensitive areas surrounding each opening, said interface panel comprising touch sensitive elements associated with each respective one of said touch sensitive areas;
a cover overlying said panel and defining a plurality of touch regions associated with each respective one of said touch sensitive areas; and
an illumination source positioned proximate said plurality of openings and illuminating said plurality of touch regions through said plurality of openings.

19. A touch control interface system in accordance with claim 18, wherein said illumination source is substantially aligned with said plurality of openings and said plurality of touch regions.

20. A touch control interface system in accordance with claim 18, wherein said plurality of touch sensitive elements extend along edges of said respective plurality of openings.
